(19) United States
(12) Patent Application Publication
(10) Pub. No.: US 2009/0018258 A1
(43) Pub. Date: Jan. 15, 2009

(54) Inkjet ink compositions comprising polymer modified pigments and methods of preparing the same

(76) Inventors: Joseph B. Carroll, Bradford, MA (US); Alexander I. Shakhnovich, Westford, MA (US)

Correspondence Address: LAW DEPARTMENT;CABOT CORPORATION, 157 CONCORD ROAD, BILLERICA, MA, 01821, US

(21) Appl. No.: 12/217,586

(22) Filed: Jul. 7, 2008

Related U.S. Application Data
(60) Provisional application No. 60/949,393, filed on Jul. 12, 2007.

(51) Int. Cl. C08L 35/06; C08L 33/00; C08L 77/00; C08L 67/00

(52) U.S. Cl. 524/549; 524/555; 524/556; 524/606; 524/599

(57) ABSTRACT

The present invention relates to an inkjet ink composition comprising a liquid vehicle and at least one polymer modified pigment. In one embodiment, the polymer modified pigment comprises the combination product of a pigment, a polymer, and a base, wherein the polymer is a styrene-maleic anhydride polymer or an alternating copolymer comprising at least one segment having the formula —[HB-A]ₓ-. In a second embodiment, the polymer modified pigment comprises a pigment and a polymer, wherein the polymer is a styrene-maleic acid polymer or salt thereof or an alternating copolymer comprising at least one segment having the formula —[HB-A′]ₓ-. Methods of preparing the inkjet ink compositions are also disclosed.

### CROSS-REFERENCE TO RELATED APPLICATIONS

This patent application claims the benefit of U.S. Provisional Patent Application No. 60/949,393, filed Jul. 12, 2007.

### BACKGROUND OF THE INVENTION

1. Field of the Invention

The present invention relates to inkjet ink compositions comprising a polymer modified pigment.

2. Description of the Related Art

An inkjet ink composition generally consists of a vehicle, which functions as a carrier, and a colorant such as a dye or pigment. Additives and/or cosolvents can also be incorporated in order to adjust the inkjet ink to attain the desired overall performance properties.

In general, pigments alone are not readily dispersible in liquid vehicles, and a variety of techniques have been developed that can provide stable pigment dispersions useful in applications such as inkjet printing. For example, dispersants can be added to the pigment to improve its dispersibility in a particular medium. Examples of dispersants include water-soluble polymers and surfactants.

A wide variety of polymers have been used as dispersants, and these are often tailored to the type of pigment to be dispersed. Typically, polymeric dispersants have a molecular weight less than 20,000 in order to maintain solubility and to provide pigment stability. Dispersants having pigment derivatives attached to a polymeric group have also been described. For example, GB 2036779 describes polyether disazo dyestuffs having specified formulas which include a disazo dye and an attached polyalkylene oxide group. These dyestuffs are useful for dying and printing synthetic fibers. Also, JP 63-175080, JP 06-065521, JP 07-041689, and JP 2993088d each describe pigment compositions comprising a pigment and a polymer having an attached quinacridone derivative, which can be used for dispersing a pigment for coatings or varnishes. However, none of these references teaches the use of such additives for the demanding requirements of inkjet ink compositions.

Methods for the preparation of modified pigment products have also been developed which can provide a pigment with a variety of different attached functional groups. For example, U.S. Pat. No. 5,851,280 discloses methods for the attachment of organic groups onto pigments including, for example, attachment via a diazonium reaction wherein the organic group is part of the diazonium salt. Other methods to prepare modified pigments, including those having attached polymeric groups, have also been described. For example, PCT Publication No. WO 01/51566 discloses methods of making a modified pigment by reacting a first chemical group and a second chemical group to form a pigment having attached a third chemical group. These methods provide modified pigments having attached groups and pigment compositions, including inkjet ink compositions, with improved overall performance properties that do not require the addition of dispersant. However, a pigment modification step is needed.

As the inkjet printing industry moves towards print performance similar to that of laser printing, there remains a need for inkjet ink compositions comprising pigments and a dispersant having improved properties, such as improved stability, thereby providing alternatives to modified pigment dispersions.

### SUMMARY OF THE INVENTION

The present invention relates to an inkjet ink composition comprising a liquid vehicle and at least one polymer modified pigment. In one embodiment, the polymer modified pigment comprises the combination product of a pigment, a polymer, and a base, wherein the polymer is a styrene-maleic anhydride polymer or an alternating copolymer comprising at least one segment having the formula —[HB-A]ₓ-HB-, wherein HB is a hydrophobic block, A is a polymerized monomer unit comprising at least one anhydride group, carboxylic ester group, carboxylic amide group, or mixtures thereof, and x is 5 to 50. In a second embodiment, the polymer modified pigment comprises a pigment and a polymer, wherein the polymer is a styrene-maleic acid polymer or salt thereof or an alternating copolymer comprising at least one segment having the formula —[HB-A′]ₓ-, wherein HB and x are as defined above and A′ is a polymerized monomer unit comprising at least one carboxylic acid group or salt thereof.

The present invention further relates to a method of preparing a polymer modified pigment comprising the steps of combining a pigment and a polymer, wherein the polymer is a styrene-maleic anhydride polymer or an alternating copolymer having the formula —[HB-A]ₓ-, and hydrolyzing at least a portion of the polymer with a base to form the polymer modified pigment comprising the pigment and a styrene-maleic acid polymer or salt thereof or an alternating copolymer having the formula —[HB-A′]ₓ-, wherein HB, A, A′, and x are as defined above.

It is to be understood that both the foregoing general description and the following detailed description are exemplary and explanatory only and are intended to provide further explanation of the present invention, as claimed.

### DETAILED DESCRIPTION OF THE INVENTION

The present invention relates to inkjet ink compositions comprising polymer modified pigments and methods for preparing the same.

The inkjet ink composition of the present invention comprises a liquid vehicle and a polymer modified pigment. The liquid vehicle may be either a non-aqueous vehicle or an aqueous vehicle. Preferably, the vehicle is an aqueous vehicle, which is a vehicle that contains greater than 50% water. For example, the aqueous vehicle can be water or mixtures of water with water miscible solvents such as alcohols. Preferably the aqueous vehicle is water, and the inkjet ink composition is an aqueous inkjet ink composition.

The polymer modified pigment of the inkjet ink composition of the present invention comprise a pigment and a polymer. The pigment can be any type of pigment conventionally used by those skilled in the art, including carbonaceous black pigments and organic colored pigments. Mixtures of different pigments can also be used. Representative examples of carbonaceous black pigments include various carbon blacks (Pigment Black 7) such as channel blacks, furnace blacks, gas blacks, and lamp blacks, and include, for example, carbon blacks sold under the Regal®, Black Pearls®, Elftex®, Monarch®, Mogul®, and Vulcan® trademarks available from Cabot Corporation (such as Black Pearls® 2000, Black Pearls® 1400, Black Pearls® 1300, Black Pearls® 1100, Black Pearls® 1000, Black Pearls® 900, Black Pearls® 880, Black Pearls® 800, Black Pearls® 700, Black Pearls® 570, Black Pearls® L, Elftex® 8, Monarch® 1400, Monarch® 1300, Monarch® 1100, Monarch® 1000, Monarch® 900, Monarch® 880, Monarch® 800, Monarch® 700, Regal® 660, Mogul® L, Regal® 330, Regal® 400, Vulcan® P). Carbon blacks available from other suppliers can be used. Representative examples of organic colored pigments include, for example, blue, black, brown, cyan, green, white, violet, magenta, red, orange, or yellow organic pigments. Suitable classes include, for example, anthraquinones, phthalocyanine blues, phthalocyanine greens, diazos, monoazos, pyranthrones, perylenes, heterocyclic yellows, quinacridones, quinolonoquinolones, and (thio)indigoids. Such pigments are commercially available in either powder or press cake form from a number of sources including, BASF Corporation, Engelhard Corporation, Sun Chemical Corporation, Clariant, and Dianippon Ink and Chemicals (DIC). Examples of other suitable colored pigments are described in the Colour Index, 3rd edition (The Society of Dyers and Colourists, 1982). Preferably the pigment is a cyan pigment, such as Pigment Blue 15 or Pigment Blue 60, a magenta pigment, such as Pigment Red 122, Pigment Red 177, Pigment Red 185, Pigment Red 202, or Pigment Violet 19, a yellow pigment, such as Pigment Yellow 74, Pigment Yellow 128, Pigment Yellow 139, Pigment Yellow 155, Pigment Yellow 180, Pigment Yellow 185, Pigment Yellow 218, Pigment Yellow 220, or Pigment Yellow 221, an orange pigment, such as Pigment Orange 168, a green pigment, such as Pigment Green 7 or Pigment Green 36, or black pigment, such as carbon black.

The pigment may also be a pigment, particularly a carbonaceous black pigment, that has been oxidized using an oxidizing agent in order to introduce ionic and/or ionizable groups onto the surface. Pigments prepared in this way have been found to have a higher degree of oxygen-containing groups on the surface. Oxidizing agents include, but are not limited to, oxygen gas, ozone, NO₂ (including mixtures of NO₂ and air), peroxides such as hydrogen peroxide, persulfates, including sodium, potassium, or ammonium persulfate, hypohalites such a sodium hypochlorite, halites, halates, or perhalates (such as sodium chlorite, sodium chlorate, or sodium perchlorate), oxidizing acids such a nitric acid, and transition metal containing oxidants, such as permanganate salts, osmium tetroxide, chromium oxides, or ceric ammonium nitrate. Mixtures of oxidants may also be used, particularly mixtures of gaseous oxidants such as oxygen and ozone. In addition, pigments, particularly carbonaceous black pigments, prepared using other surface modification methods to introduce ionic or ionizable groups onto a pigment surface, such as chlorination and sulfonylation, may also be used.

The pigment may also be a modified pigment comprising a pigment having attached at least one organic group. Preferably the organic group is directly attached. For example, the modified pigment may be a pigment having attached at least one ionic group, at least one ionizable group, or a mixture thereof. Preferably the ionic or ionizable group is an anionic or anionizable group. Anionic groups are associated with a counterion of the opposite charge including inorganic or organic counterions such as Na⁺, K⁺, Li⁺, NH₄⁺, NR′₄⁺, where R′, which can be the same or different, represents hydrogen or an organic group such as a substituted or unsubstituted aryl and/or alkyl group. Anionizable groups are ones that are capable of forming anionic groups in the medium of use. Preferably, the attached group is an organic group. Organic anionic groups include those described in U.S. Pat. No. 5,698,016, the description of which is fully incorporated herein by reference.

Anionic groups are negatively charged ionic groups that may be generated from groups having ionizable substituents that can form anions (anionizable groups), such as acidic substituents. They may also be the anion in the salts of ionizable substituents. Representative examples of anionic groups include —COO⁻, —SO₃⁻, —OSO₃⁻, —HPO₃⁻, OPO₃⁻², and —PO₃⁻². Representative examples of anionizable groups include —COOH, —SO₃H, —PO₃H₂, —R′SH, —R′OH, and —SO₂NHCOR′, where R′, which can be the same or different, represents hydrogen or an organic group such as a substituted or unsubstituted aryl and/or alkyl group. For example, the attached organic group comprises a carboxylic acid group, a sulfonic acid group, a phosphonic acid group, or salts thereof, including a —C₆H₄COOH group, a —C₆H₄SO₃H, or salts thereof. In addition, the organic group may be a polymeric group that comprises an ionic group, ionizable group, or salt thereof.

The modified pigments may be prepared using any method known to those skilled in the art such that organic chemical groups are attached to the pigment. For example, the modified pigments can be prepared using the methods described in U.S. Pat. Nos. 5,554,739, 5,707,432, 5,837,045, 5,851,280, 5,885,335, 5,895,522, 5,900,029, 5,922,118, and 6,042,643, and PCT Publication WO 99/23174, the descriptions of which are fully incorporated herein by reference. Such methods provide for a more stable attachment of the groups onto the pigment compared to dispersant type methods, which use, for example, polymers and/or surfactants. Other methods for preparing the modified pigments include reacting a pigment having available functional groups with a reagent comprising the organic group, such as is described in, for example, U.S. Pat. No. 6,723,783, which is incorporated in its entirety by reference herein. Such functional pigments may be prepared using the methods described in the references incorporated above. In addition modified carbon blacks containing attached functional groups may also be prepared by the methods described in U.S. Pat. Nos. 6,831,194 and 6,660,075, U.S. Patent Publication Nos. 2003-0101901 and 2001-0036994, Canadian Patent No. 2,351,162, European Patent No. 1 394 221, and PCT Publication No. WO 04/63289, as well as in N. Tsubokawa, Polym. Sci., 17, 417, 1992, each of which is also incorporated in their entirety by reference herein.

As discussed above, the polymer modified pigment comprises a pigment and a polymer. In a first embodiment of the present invention, the polymer modified pigment comprises the combination product of the pigment, the polymer, and a base. The polymer and the base are described in more detail below for this embodiment. By “combination product” is meant that the polymer modified pigment is the product that results from the combination of the pigment, the polymer, and the base, in any order. Preferably, the combination product is the product resulting from the combination of the polymer and the pigment and subsequently combination with the base. For example, the combination product may be formed by combining a dispersion of the pigment with the polymer in a water miscible organic solvent, such as N-methyl pyrrolidone (NMP), methyl ethyl ketone (MEK) or 2-pyrrolidone (2P), and an aqueous solution of the base. Alternatively, the combination product may be the product resulting from combining the pigment and the base, such as an alkaline aqueous dispersion of the pigment, with subsequent combination with the polymer, either in an aqueous solvent or in a water miscible organic solvent. Other methods are described in more detail below.

For this first embodiment, the polymer is a styrene-maleic anhydride polymer, which is a polymer prepared by the polymerization of styrene or a styrenic monomer and maleic anhydride or derivatives thereof. For example, the styrene-maleic anhydride polymer may be a copolymer of styrene and maleic anhydride. Additional monomers, such as acrylate and methacrylates, may also be present, but in preferably low levels. For example, the styrene-maleic anhydride polymer can be a polymer of styrene, maleic anhydride, and an additional monomer having a mole ratio of polymerized styrene and maleic anhydride to other polymerized monomer that is greater than 1/1, such as greater than 5/1, greater than 10/1, and greater than 20/1. Such polymers can be prepared using any method known in the art, including polymerization using a continuous monomer feed as well as using a one-pot polymerization process. Preferred are styrene-maleic anhydride copolymers prepared using a continuous monomer feed method.

Other examples of styrene-maleic anhydride polymers include functionalized styrene-maleic anhydride polymers, which are polymers prepared by the polymerization of styrene and maleic anhydride that have been further reacted, for example, with alcohols to form ester groups or with amines to form amide or imide groups. Specific examples of functionalized styrene-maleic anhydride polymers include polymers comprising units of polymerized styrene and units of the half ester or amide of polymerized maleic anhydride (thus comprising units having formulas such as —(CH(COOH)—CH(COOR)— or —(CH(COOH)—CH(CONR₂)—, wherein R is a C1-C20, preferably a C6-C18, alkyl, an aralkyl, or an aryl group). Partially functionalized styrene-maleic anhydride polymers can also be used, in which some, but not all of the polymerized maleic anhydride units have been functionalized. Examples of these polymers include styrene-maleic anhydride-maleic acid ester polymers and styrene-maleic anhydride-maleic acid amide polymers. In addition, polymers comprising units of polymerized styrene and units of the imide of polymerized maleic anhydride may also be used.

Preferably, the styrene-maleic anhydride polymer has a low acid number. For example, the styrene-maleic anhydride polymer may have an acid number less than about 190, including less than about 180, less than about 175, or even less than about 160, 150, or 140. The acid number represents the equivalents of base needed to fully hydrolyze the anhydride groups and can be determined using any method known in the art. Also, preferably, the amount of maleic anhydride, or functionalized derivative of maleic anhydride, in the polymer is low. For example, the styrene-maleic anhydride polymer can be a polymer having a mole ratio of polymerized styrene to polymerized maleic anhydride that is greater than or equal to about 5/1, including greater than or equal to about 6/1, and more preferably greater than or equal to about 7/1, including greater than or equal to about 8/1. Also, the polymer may be a functionalized styrene-maleic anhydride polymer, such a styrene-maleic anhydride-maleic acid ester polymer or a styrene-maleic anhydride-maleic acid amide polymer, having a mole ratio of polymerized styrene to polymerized maleic monomer (maleic anhydride and maleic acid ester or amide) of greater than or equal to about 3/1, including greater than or equal to about 4/1. For these preferred styrene-maleic anhydride polymers, more preferably the polymers are ones that are not dispersible or soluble in water and, most preferably, also cannot be substantially hydrolyzed or ionized (for functionalized styrene-maleic anhydride polymers) in water without the use of a water miscible solvent.

Alternatively, for this first embodiment, the polymer is an alternating copolymer comprising at least one segment having the formula —[HB-A]ₓ-, such as at an alternating copolymer comprising at least one segment having the formula ‘3[HB-A]ₓ-HB—. HB is a hydrophobic block, which is a segment of polymerized monomer that is not water soluble, and A is a polymerized monomer unit comprising at least one hydrolysable carboxylic group, which is a group that, when combined with a base, forms a carboxylic acid group or salt thereof. As an “alternating copolymer”, the polymer comprises at least one segment with a hydrophobic block, HB, alternating with or followed by a polymerized monomer, A, and, this HB-A alternating segment is repeated. Such polymers may also be referred to as periodic polymers. The number of repeating HB-A segments is x, and, for this polymer, x is 5 to 50, preferably 7-30, and more preferably 10-25.

Thus, the polymer is an alternating or periodic copolymer comprising at least one segment having hydrophobic blocks alternating with polymerized monomer units comprising at least one hydrolysable carboxylic group. Examples of suitable polymerized monomer units, A, include monomers comprising at least one anhydride group, imide group, carboxylic ester group, carboxylic amide group, or mixtures thereof. Each of these can be hydrolyzed either under acidic or basic conditions to form polymerized units comprising at least one carboxylic acid group or salt thereof. Preferably, A comprises an anhydride group. For example, A can be a polymerized maleic anhydride unit, which can be reacted to form a maleic acid ester unit, a maleic acid amide unit, a maleic acid unit (dicarboxylic acid), or salts thereof. Also, A can be the ester or amide derivative of a polymerized maleic anhydride unit, and any of those described in more detail above can be used.

The hydrophobic block, HB, can be any known in the art but is preferably a styrenic block, comprising polymerized units of styrene or derivatives thereof. Preferably HB is a polymerized styrene block. As a block, the number of polymerized styrene units is greater than 1, and preferably, HB is a polymerized styrene block comprising greater than 3 polymerized styrene units and more preferably greater than 6 polymerized styrene units, such as greater than or equal to 8 polymerized styrene units. Preferably, the block comprises less than 20 polymerized styrene units, such as less than 15 units or less than 10 units.

Thus, preferably the alternating copolymer having the formula ‘3[HB-A]ₓ- is a styrene-maleic anhydride polymer, which is a polymer comprising blocks of polymerized styrene or styrenic monomers alternating with a polymerized maleic anhydride unit or derivative thereof. Specific examples include any of the styrene-maleic anhydride polymers described in more detail above, such as a styrene-maleic anhydride copolymer, a styrene-maleic anhydride-maleic acid ester polymer, or a styrene-maleic anhydride-maleic acid amide polymer. Such polymers are preferably prepared using a continuous monomer feed method, which would be expected to produce alternating copolymers having the desired formula.

The relative amounts of HB and A units can be varied, but preferably the amount of A is such that the alternating copolymer has a low acid number. For example, the alternating copolymer may have an acid number less than about 190, including less than about 180, less than about 175, or even less than about 160, 150, or 140. Thus, the amount of A in the polymer is preferably low. For example, the alternating copolymer can be a polymer having a mole ratio of polymerized styrene to polymerized maleic anhydride that is greater than or equal to about 5/1, including greater than or equal to about 6/1, and more preferably greater than or equal to about 7/1, including greater than or equal to about 8/1. Also, the alternating copolymer may be a styrene-maleic acid ester polymer or a styrene-maleic acid amide polymer having a mole ratio of polymerized styrene to polymerized maleic monomer (maleic acid ester or amide) of greater than or equal to about 3/1, including greater than or equal to about 4/1.

For this first embodiment, whether the polymer is a styrene-maleic anhydride polymer, as described above, or an alternating copolymer having the formula described above, the polymer can have any molecular weight, depending, for example, on the desired properties of the inkjet ink composition. For example, the molecular weight (such as the weight average molecular weight) can be greater than or equal to about 5000, such as greater than or equal to about 7000, including greater than or equal to about 10000. The molecular weight may also be less than or equal to about 100000, such as less than or equal to about 50000, including less than or equal to about 25000. These polymers can also have any polydispersity value, including, for example, a polydispersity less than about 3, such as less than about 2.5 and less than about 2.

As discussed above, in a first embodiment of the present invention, the polymer modified pigment comprises the combination product of a pigment, a polymer, and a base. The base can be any known in the art but is preferably one that soluble in water. For example, the base can be an hydroxide reagent, which is any reagent that comprises an OH⁻ ion, such as a salt having an hydroxide counterion. Specific examples include sodium hydroxide, potassium hydroxide, lithium hydroxide, ammonium hydroxide, and organic quaternary ammonium hydroxides, including tetraalkyl ammonium hydroxides such as tetramethyl and tetraethyl ammonium hydroxide. Other hydroxide salts, as well as mixtures of hydroxide reagents, can also be used. Furthermore, other alkaline reagents may also be used which generate OH- ions in an aqueous medium. Examples include carbonates such as sodium carbonate, bicarbonates such as sodium bicarbonate, and alkoxides such as sodium methoxide and sodium ethoxide.

The relative amounts of pigment, polymer, and base can be varied depending on the desired properties of the inkjet ink composition. For example, the polymer and pigment may be used in a ratio of from about 2:1 to about 1:10 polymer to pigment, including, for example, from about 1:1 to about 1:5 and from about 1:1 to about 1:3. Also, the base may be used in varying levels depending on, for example, the amount of either maleic anhydride groups or A groups in the polymer. For example, the base may be used in a ratio of from about 10:1 to about 1:5 moles of maleic anhydride or A group to moles of base, including, for example, from about 5:1 to about 1:2 and from about 3:1 to about 1:1.

While not wishing to be bound by theory, it is believed that, upon combining the polymer, the pigment, and the base, the polymer reacts with the base forming a hydrolyzed or ionized polymer, which adsorbs onto or coats the pigment. Thus, it is believed that the combination product is a polymer coated pigment in which the hydrolyzed or ionized polymer is substantially adsorbed or coated onto the pigment and is therefore not a pigment having an attached polymer, in which the polymer or a derivative of the polymer reacts with the pigment.

Thus, for this first embodiment, the combination product can be a coated pigment comprising a pigment and a hydrolyzed or ionized polymer, formed from the polymer used to prepare the combination product. For example, the hydrolyzed polymer may be a styrene-maleic acid polymer or a salt thereof, which is a polymer comprising polymerized units of styrene and polymerized units of maleic acid, such as a styrene-maleic acid copolymer, a styrene-maleic anhydride-maleic acid polymer, or salts thereof. Also, the styrene-maleic acid polymer may be a functionalized styrene-maleic acid polymer, which is a polymer comprising polymerized units of styrene and derivatives of polymerized units of maleic acid, such as a styrene-maleic acid-maleic acid ester polymer, a styrene-maleic anhydride-maleic acid-maleic acid ester polymer, a styrene-maleic acid-maleic acid amide polymer, a styrene-maleic anhydride-maleic acid-maleic acid amide polymer, or a salt thereof. Alternatively, the hydrolyzed polymer may be an alternating copolymer comprising at least one segment having the formula —[HB-A′]ₓ-, such a at least one segment having the formula —[HB-A′]ₓ-HB—. HB is a hydrophobic block and can be any of those described above, and x is as described above and is preferably 5 to 50. A′ is a polymerized monomer unit comprising at least one carboxylic acid group or salt thereof. Such a group can result, for example, from the reaction of any of the segments A described above. For example, the alternating copolymer may be a styrene maleic acid polymer, comprising at least one segment of a styrene block alternating with a polymerized monomer comprising a carboxylic acid group or salt thereof, such as a styrene-maleic acid copolymer, a styrene-maleic anhydride-maleic acid polymer, a styrene-maleic acid-maleic acid ester polymer, a styrene-maleic anhydride-maleic acid-maleic acid ester polymer, a styrene-maleic acid-maleic acid amide polymer, a styrene-maleic anhydride-maleic acid-maleic acid amide polymer, or a salt thereof.

The polymer modified pigment may be prepared by a method comprising the steps of combining the pigment and the polymer, such as the styrene-maleic anhydride polymer or the alternating copolymer comprising at least one segment having the formula —[HB-A]ₓ-, followed by reacting at least a portion of the polymer with the base to form the polymer modified pigment. If the polymer is a styrene-maleic anhydride polymer, then the polymer modified pigment comprises the pigment and a styrene-maleic acid polymer or salt thereof. If the polymer is an alternating copolymer comprising at least one segment having the formula —[HB-A]ₓ-, then the polymer modified pigment comprises the pigment and an alternating copolymer comprising at least one segment having the formula —[HB-A′]ₓ. HB, A, A′, and x are as described above. For example, as discussed above, a dispersion of the pigment with the polymer in a water miscible organic solvent and an aqueous solution of the base may be combined to form the polymer modified pigment. Thus, the present invention further relates to a method of preparing a polymer modified pigment.

In a second embodiment of the present invention, the polymer modified pigment comprises a pigment and a hydrolyzed polymer. The hydrolyzed polymer is a styrene-maleic acid polymer or a salt thereof, and can be any of those described in more detail above, including a functionalized styrene-maleic acid polymer. Alternatively, the hydrolyzed polymer is an alternating copolymer comprising at least one segment having the formula —[HB-A′]ₓ-, including an alternating copolymer comprising at least one segment having the formula —[HB-A′]ₓ-HB—, wherein HB, A′, and x are as described above. The alternating copolymer can be any of those described in more detail above. The polymer modified pigment may be prepared using a variety of methods but is preferably prepared using the method of the present invention.

The inkjet ink compositions of the present invention, comprising a liquid vehicle and a polymer modified pigment as described above, can be prepared using any method known in the art. For example, the polymer modified pigment may be combined with the liquid vehicle with agitation to produce a stable dispersion. Any equipment known in the art, such as a media or ball mill, or other high shear mixing equipment can be used, and various conventional milling media may also be used. Other methods for forming the dispersion will be known to one skilled in the art.

The amount of polymer modified pigment present in the inkjet ink composition can be varied but is typically in an amount effective to provide the desired image quality (for example, optical density) without detrimentally affecting the performance of the inkjet ink. For example, typically, the polymer modified pigment will be present in an amount ranging from about 0.1% to about 20% based on the weight of the inkjet ink composition.

The inkjet ink composition of the present invention can be formed with a minimum of additional components (additives and/or cosolvents) and processing steps. However, suitable additives may be incorporated in order to impart a number of desired properties while maintaining the stability of the compositions. For example, additional surface active agents, humectants, drying accelerators, penetrants, biocides, binders, and pH control agents, as well as other additives known in the art, may be added. The amount of a particular additive will vary depending on a variety of factors but generally ranges between 0% and 40%.

Surface active agents may be added to further enhance the colloidal stability of the composition or to change the interaction of the ink with either the printing substrate, such as printing paper, or with the ink printhead. Various anionic, cationic and nonionic surface active agents can be used in conjunction with the ink composition of the present invention, and these may be in solid form or as a water solution.

Representative examples of anionic surface active agents include, but are not limited to, higher fatty acid salts, higher alkyldicarboxylates, sulfuric acid ester salts of higher alcohols, higher alkyl-sulfonates, alkylbenzenesulfonates, alkylnaphthalene sulfonates, naphthalene sulfonates (Na, K, Li, Ca, etc.), formalin polycondensates, condensates between higher fatty acids and amino acids, dialkylsulfosuccinic acid ester salts, alkylsulfosuccinates, naphthenates, alkylether carboxylates, acylated peptides, α-olefin sulfonates, N-acrylmethyl taurine, alkylether sulfonates, secondary higher alcohol ethoxysulfates, polyoxyethylene alkylphenylether sulfates, monoglycylsulfates, alkylether phosphates, alkyl phosphates, and alkyl phosphonates. For example, polymers and copolymers of styrene sulfonate salts, unsubstituted and substituted naphthalene sulfonate salts (e.g. alkyl or alkoxy substituted naphthalene derivatives), aldehyde derivatives (such as unsubstituted alkyl aldehyde derivatives including formaldehyde, acetaldehyde, propylaldehyde, and the like), maleic acid salts, and mixtures thereof may be used as the anionic dispersing aids. Salts include, for example, Na⁺, Li⁺, K⁺, Cs⁺, Rb⁺, and substituted and unsubstituted ammonium cations. Specific examples include, but are not limited to, commercial products such as Versa® 4, Versa® 7, and Versa® 77 (National Starch and Chemical Co.); Lomar® D (Diamond Shamrock Chemicals Co.); Daxad®19 and Daxad® K (W. R. Grace Co.); and Tamol® SN (Rohm & Haas). Representative examples of cationic surfactants include aliphatic amines, quaternary ammonium salts, sulfonium salts, phosphonium salts and the like.

Representative examples of nonionic surface active agents that can be used in ink jet inks of the present invention include fluorine derivatives, silicone derivatives, acrylic acid copolymers, polyoxyethylene alkyl ether, polyoxyethylene alkylphenyl ether, polyoxyethylene secondary alcohol ether, polyoxyethylene styrol ether, ethoxylated acetylenic diols (such as Surfynol® 420, Surfynol® 440, and Surfynol® 465, available from Air Products), polyoxyethylene lanolin derivatives, ethylene oxide derivatives of alkylphenol formalin condensates, polyoxyethylene polyoxypropylene block polymers, fatty acid esters of polyoxyethylene polyoxypropylene alkylether polyoxyethylene compounds, ethylene glycol fatty acid esters of polyethylene oxide condensation type, fatty acid monoglycerides, fatty acid esters of polyglycerol, fatty acid esters of propylene glycol, cane sugar fatty acid esters, fatty acid alkanol amides, polyoxyethylene fatty acid amides and polyoxyethylene alkylamine oxides. For example, ethoxylated monoalkyl or dialkyl phenols may be used, such as Igepal® CA and CO series materials (Rhone-Poulenc Co.), Brij® Series materials (ICI Americas, Inc.), and Triton® series materials (Union Carbide Company). These nonionic surface active agents can be used alone or in combination with the aforementioned anionic and cationic dispersants.

The surface active agent may also be a natural polymer or a synthetic polymer dispersant. Specific examples of natural polymer dispersants include proteins such as glue, gelatin, casein and albumin; natural rubbers such as gum arabic and tragacanth gum; glucosides such as saponin; alginic acid, and alginic acid derivatives such as propyleneglycol alginate, triethanolamine alginate, and ammonium alginate; and cellulose derivatives such as methyl cellulose, carboxymethyl cellulose, hydroxyethyl cellulose and ethylhydroxy cellulose. Specific examples of polymeric dispersants, including synthetic polymeric dispersants, include polyvinyl alcohols, such as Elvanols from DuPont, Celvoline from Celanese, polyvinylpyrrolidones such as Luvatec from BASF, Kollidon and Plasdone from ISP, and PVP-K, Glide, acrylic or methacrylic resins (often written as “(meth)acrylic”) such as poly(meth)acrylic acid, Ethacryl line from Lyondell, Alcosperse from Alco, acrylic acid-(meth)acrylonitrile copolymers, potassium (meth)acrylate-(meth)acrylonitrile copolymers, vinyl acetate-(meth)acrylate ester copolymers and (meth)acrylic acid-(meth)acrylate ester copolymers; styrene-acrylic or methacrylic resins such as styrene-(meth)acrylic acid copolymers, such as the Joncryl line from BASF, Carbomers from Noveon, styrene-(meth)acrylic acid-(meth)acrylate ester copolymers, such as the Joncryl polymers from BASF, styrene-α-methylstyrene-(meth)acrylic acid copolymers, styrene-α-methylstyrene-(meth)acrylic acid-(meth)acrylate ester copolymers; styrene-maleic acid copolymers; styrene-maleic anhydride copolymers, such as the SMA™ resins from Sartomer that can be hydrolyzed in water, vinyl naphthalene-acrylic or methacrylic acid copolymers; vinyl naphthalene-maleic acid copolymers; and vinyl acetate copolymers such as vinyl acetate-ethylene copolymer, vinyl acetate-fatty acid vinyl ethylene copolymers, vinyl acetate-maleate ester copolymers, vinyl acetate-crotonic acid copolymer and vinyl acetate-acrylic acid copolymer; and salts thereof. Polymers, such as those listed above, variations and related materials, that can be used for dispersants and additives in inkjet inks are included in the Tego products from Degussa, the Ethacryl products from Lyondell, the Joncryl polymers from BASF, the EFKA dispersants from Ciba, and the Disperbyk and Byk dispersants from BYK Chemie.

Humectants and water soluble organic compounds may also be added to the inkjet ink composition of the present invention, particularly for the purpose of preventing clogging of the nozzle as well as for providing paper penetration (penetrants), improved drying (drying accelerators), and anti-cockling properties. Specific examples of humectants and other water soluble compounds that may be used include low molecular-weight glycols such as ethylene glycol, diethylene glycol, triethylene glycol, tetraethylene glycol and dipropylene glycol; diols containing from about 2 to about 40 carbon atoms, such as 1,3-pentanediol, 1,4-butanediol, 1,5-pentanediol, 1,4-pentanediol, 1,6-hexanediol, 1,5-hexanediol, 2,6-hexanediol, neopentylglycol (2,2-dimethyl-1,3-propanediol), 1,3-propanediol, 1,4-butanediol, 1,5-pentanediol, 1,6-hexanediol, 1,2,6-hexanetriol, poly(ethylene-co-propylene) glycol, and the like, as well as their reaction products with alkylene oxides, including ethylene oxides, including ethylene oxide and propylene oxide; triol derivatives containing from about 3 to about 40 carbon atoms, including glycerine, trimethylolpropane, 1,3,5-pentanetriol, 1,2,6-hexanetriol, and the like as well as their reaction products with alkylene oxides, including ethylene oxide, propylene oxide, and mixtures thereof; neopentylglycol, (2,2-dimethyl-1,3-propanediol), and the like, as well as their reaction products with alkylene oxides, including ethylene oxide and propylene oxide in any desirable molar ratio to form materials with a wide range of molecular weights; thiodiglycol; pentaerythritol and lower alcohols such as ethanol, propanol, iso-propyl alcohol, n-butyl alcohol, sec-butyl alcohol, and tert-butyl alcohol, 2-propyn-1-ol (propargyl alcohol), 2-buten-1-ol, 3-buten-2-ol, 3-butyn-2-ol, and cyclopropanol; amides such as dimethyl formaldehyde and dimethyl acetamide; ketones or ketoalcohols such as acetone and diacetone alcohol; ethers such as tetrahydrofuran and dioxane; cellosolves such as ethylene glycol monomethyl ether and ethylene glycol monoethyl ether, triethylene glycol monomethyl (or monoethyl) ether; carbitols such as diethylene glycol monomethyl ether, diethylene glycol monoethyl ether, and diethylene glycol monobutyl ether; lactams such as 2-pyrrolidone, N-methyl-2-pyrrolidone and ε-caprolactam; urea and urea derivatives; inner salts such as betaine, and the like; thio (sulfur) derivatives of the aforementioned materials including 1-butanethiol; t-butanethiol 1-methyl-1-propanethiol, 2-methyl-1-propanethiol; 2-methyl-2-propanethiol; thiocyclopropanol, thioethyleneglycol, thiodiethyleneglycol, trithio- or dithio-diethyleneglycol, and the like; hydroxyamide derivatives, including acetylethanolamine, acetylpropanolamine, propylcarboxyethanolamine, propylcarboxy propanolamine, and the like; reaction products of the aforementioned materials with alkylene oxides; and mixtures thereof. Additional examples include saccharides such as maltitol, sorbitol, gluconolactone and maltose; polyhydric alcohols such as trimethylol propane and trimethylol ethane; N-methyl-2-pyrrolidone; 1,3-dimethyl-2-imidazolidinone; sulfoxide derivatives containing from about 2 to about 40 carbon atoms, including dialkylsulfides (symmetric and asymmetric sulfoxides) such as dimethylsulfoxide, methylethylsulfoxide, alkylphenyl sulfoxides, and the like; and sulfone derivatives (symmetric and asymmetric sulfones) containing from about 2 to about 40 carbon atoms, such as dimethylsulfone, methylethylsulfone, sulfolane (tetramethylenesulfone, a cyclic sulfone), dialkyl sulfones, alkyl phenyl sulfones, dimethylsulfone, methylethylsulfone, diethylsulfone, ethylpropylsulfone, methylphenylsulfone, methylsulfolane, dimethylsulfolane, and the like. Such materials may be used alone or in combination.

Biocides and/or fungicides may also be added to the inkjet ink composition of the present invention. Biocides are important in preventing bacterial growth since bacteria are often larger than ink nozzles and can cause clogging as well as other printing problems. Examples of useful biocides include, but are not limited to, benzoate or sorbate salts, and isothiazolinones.

Various polymeric binders can also be used in conjunction with the inkjet ink composition of the present invention to adjust the viscosity of the composition as well as to provide other desirable properties. Suitable polymeric binders include, but are not limited to, water soluble polymers and copolymers such as gum arabic, polyacrylate salts, polymethacrylate salts, polyvinyl alcohols (Elvanols from DuPont, Celvoline from Celanese), hydroxypropylenecellulose, hydroxyethylcellulose, polyvinylpyrrolidinone (such as Luvatec from BASF, Kollidon and Plasdone from ISP, and PVP-K, Glide), polyvinylether, starch, polysaccharides, polyethyleneimines with or without being derivatized with ethylene oxide and propylene oxide including the Discole® series (DKS International); the Jeffamine® series (Huntsman); and the like. Additional examples of water-soluble polymer compounds include various dispersants or surfactants described above, including, for example, styrene-acrylic acid copolymers (such as the Joncryl line from BASF, Carbomers from Noveon), styrene-acrylic acid-alkyl acrylate terpolymers, styrene-methacrylic acid copolymers (such as the Joncryl line from BASF), styrene-maleic acid copolymers (such as the SMA™ resins from Sartomer), styrene-maleic acid-alkyl acrylate terpolymers, styrene-methacrylic acid-alkyl acrylate terpolymers, styrene-maleic acid half ester copolymers, vinyl naphthalene-acrylic acid copolymers, alginic acid, polyacrylic acids or their salts and their derivatives. In addition, the binder may be added or present in dispersion or latex form. For example, the polymeric binder may be a latex of acrylate or methacrylate copolymers (such as NeoCryl materials from NSM Neoresins, the AC and AS polymers from Alberdingk-Boley) or may be a water dispersible polyurethane (such as ABU from Alberdingk-Boley) or polyester (such as AQ polymers from Eastman Chemical). Polymers, such as those listed above, variations and related materials, that can be used for binders in inkjet inks are included in the Ethacryl products from Lyondell, the Joncryl polymers from BASF, the NeoCryl materials from NSM Neoresins, and the AC and AS polymers Alberdingk-Boley.

Various additives for controlling or regulating the pH of the inkjet ink composition of the present invention may also be used. Examples of suitable pH regulators include various amines such as diethanolamine and triethanolamine as well as various hydroxide reagents. An hydroxide reagent is any reagent that comprises an OH⁻ ion, such as a salt having an hydroxide counterion. Examples include sodium hydroxide, potassium hydroxide, lithium hydroxide, ammonium hydroxide, and tetramethyl ammonium hydroxide. Other hydroxide salts, as well as mixtures of hydroxide reagents, can also be used. Furthermore, other alkaline reagents may also be used which generate OH⁻ ions in an aqueous medium. Examples include carbonates such as sodium carbonate, bicarbonates such as sodium bicarbonate, and alkoxides such as sodium methoxide and sodium ethoxide. Buffers may also be added.

Additionally, the inkjet ink composition of the present invention may further incorporate conventional dyes to modify color balance and adjust optical density. Such dyes include food dyes, FD&C dyes, acid dyes, direct dyes, reactive dyes, derivatives of phthalocyanine sulfonic acids, including copper phthalocyanine derivatives, sodium salts, ammonium salts, potassium salts, lithium salts, and the like.

The inkjet ink compositions can be purified and/or classified to remove impurities and other undesirable free species which can co-exist as a result of the manufacturing process using any method known in the art including, for example, ultrafiltration/diafiltration using a membrane, reverse osmosis, and ion exchange. Also, the inkjet ink compositions can be subjected to a classification step, such as filtration, centrifugation, or a combination of the two methods to substantially remove particles having a size above, for example, about 1.0 micron. In this way, unwanted impurities or undesirable large particles can be removed to produce an inkjet ink composition with good overall properties.

The present invention will be further clarified by the following examples, which are intended to be only exemplary in nature.

### EXAMPLES

### Examples 1-9 and Comparative Examples 1-4

Aqueous dispersions of polymer modified pigments that can be used in inkjet ink compositions of the present invention were prepared using either Method 1 or Method 2 described below. Polymer modified pigments that were used in comparative inkjet ink compositions were prepared using the Method 3 described below.

### Method 1

Into a beaker was added 5 g of a styrene-maleic anhydride polymer having poor solubility in aqueous base and 10 g of a pigment, and to this was added 150 g of N-methyl pyrrolidone (NMP) to dissolve the polymer (other organic cosolvents could also be used, including, for example, methyl ethyl ketone (MEK) or 2-pyrrolidone (2P)) with heat (approximately 60° C.) until homogeneous. The resulting mixture was then added to an attritor bowl (available from Szegvari Attritor System) filled to half volume with zirconium silicate bead milling media (0.07-0.125 mm) with stirring (600 rpm), and the attritor mill was then allowed to operate for 30 minutes at 600 rpm. To this was added a solution of aqueous base (1M sodium hydroxide, base equivalency in excess of 2.5 times the molar maleic anhydride content). After the base was added, the attritor bowl was deluged with an excess of DI water (approximately 300 mL), subsequently inverting phases from organic to aqueous, and the mill was allowed to operate again for approximately one hour at 600 rpm. After this time, the attritor mill was then stopped, the zirconium silicate media was filtered off and rinsed several times with additional DI water, and the rinses were combined with the aqueous modified pigment dispersion filtrate. The resulting dispersion was then diafiltered with 5 equal volumes of DI water to remove any traces of organic co-solvent and then concentrated by diafiltration to 14-16% solids. The dispersion was then sonicated to reduce particle size (length of sonication varied depending on the pigment), centrifuged at 4500 RPM for 45 min at 5° C. to remove any large particles, and then decanted off, yielding the final aqueous polymer modified pigment dispersion (10-15% solids).

### Method 2

Into a beaker was added 5 g of a styrene-maleic anhydride polymer having poor solubility in aqueous base and 10 g of pigment, and to this was added 150 g of N-methyl pyrrolidone (NMP) to dissolve the polymer (other organic cosolvents could also be used, including, for example, methyl ethyl ketone (MEK) or 2-pyrrolidone (2P)) with heat (approximately 60° C.) until homogeneous. The resulting mixture was then added slowly over a few minutes to a beaker of 450 g of aqueous base (1M NaOH, base equivalency in excess of 2.5 times the molar maleic anhydride content) equipped with a rotostator blender at maximum stirring. After the addition was complete, the rotostator was allowed to operate for an additional 10 minutes and then stopped and rinsed several times with additional DI water. The resulting aqueous modified pigment dispersion was diafiltered against 5 equal volumes of DI water to remove any traces of organic co-solvent and then by diafiltration to 14-16% solids. The resulting dispersion was sonicated to reduce particle size (length of sonication varied depending on the pigment), centrifuged at 4500 RPM for 45 min at 5° C. to remove any large particles, and then decanted off, yielding the final aqueous polymer modified pigment dispersions (10-15% solids).

### Method 3 (Comparative Method)

In an attritor bowl (Szegvari Attritor System) filled to half volume with zirconium silicate bead milling media (0.07-0.125 mm) was added 10 g of pigment with stirring (600 rpm). In a separate beaker, 5 g of styrene-maleic anhydride polymer was dissolved in aqueous base (1M sodium hydroxide, base equivalency in excess of 2.5 times the molar maleic anhydride content) with heat (approximately 60° C.). The aqueous polymer solution was then added to the attritor bowl, and the resulting mixture was diluted with approximately 300 mL of DI water in order to promote efficient and fluid milling. The mill was allowed to operate for approximately one hour at 600 rpm until homogeneous. After this time, the attritor mill was stopped, the zirconium silicate media was filtered off and rinsed several times with additional DI water, and the rinses were combined with the aqueous modified pigment dispersion filtrate. The resulting dispersion was then sonicated to reduce particle size (length of sonication varied depending on the pigment), diafiltered with 5 equal volumes of DI water, concentrated by diafiltration to 10-15% solids, centrifuged at 4500 RPM for 45 minutes at 5° C. to remove any large particles, and then decanted off, yielding the final aqueous polymer modified pigment dispersion (10-15% solids).

For each example, the specific method and the types of pigments and polymers that were used are shown in Table 1 below. For Examples 1-7 and Comparative Examples 1-4, sonication time was 2-4 hours while for Examples 8-9 sonication time was 6-8 hours. The particle sizes of the resulting dispersions are shown in Table 1.

TABLE 1

| Example # | Pigment | Polymer | Method | Particle Size |
|---|---|---|---|---|
| 1 | BP700 | SMA ™ 3840F | 2 | 136 nm |
| 2 | BP700 | SMA ™ EF80 | 1 | 128 nm |
| 3 | BP700 | SMA ™ EF60 | 2 | 119 nm |
| Comp Ex 1 | BP700 | SMA ™ EF40 | 3 | 111 nm |
| Comp Ex 2 | BP700 | SMA ™ 3000 | 3 | 120 nm |
| 4 | PB15:4 | SMA ™ 3840F | 2 | 144 nm |
| 5 | PB15:4 | SMA ™ EF80 | 2 | 154 nm |
| Comp Ex 3 | PB15:4 | SMA ™ 3000 | 3 | 85 nm |
| 6 | PR122 | SMA ™ 3840F | 2 | 137 nm |
| 7 | PR122 | SMA ™ EF80 | 2 | 142 nm |
| Comp Ex 4 | PR122 | SMA ™ 3000 | 3 | 74 nm |
| 8 | PY155 | SMA ™ EF80 | 2 | 141 nm |
| 9 | PY180 | SMA ™ EF80 | 2 | 152 nm |

BP refers to Black Pearls ® carbon black,
PB refers to Pigment Blue,
PR refers to Pigment Red, and
PY refers to Pigment Yellow

SMA™ 3000, SMA™ EF40, SMA™ EF60, and SMA™ EF80 are styrene-maleic anhydride copolymers commercially available from Sartomer Company, Inc. SMA™ 3840F is a styrene-maleic anhydride copolymer functionalized with C7-C9 isoalcohols, commercially available from Sartomer Company, Inc., and therefore contains ester derivatives of polymerized maleic anhydride. The properties of each of these styrene-maleic anhydride polymers are shown in Table 2 below. In this table Sty/MAh is the molar ratio of styrene and maleic anhydride in the polymer (or styrene and maleic anhydride/maleic acid ester for SMA™ 3840F).

TABLE 2

| Polymer | Sty/MAh | Mw | Mn | Acid # | Tg |
|---|---|---|---|---|---|
| SMA ™ 3000 | 3/1 | 9500 | 3050 | 275-285 | 125 |
| SMA ™ EF40 | 4/1 | 11000 | 3600 | 195-235 | 115 |
| SMA ™ EF60 | 6/1 | 11500 | 5500 | 141-171 | 106 |
| SMA ™ EF80 | 8/1 | 14400 | 7500 | 105-135 | 104 |
| SMA ™ 3840F | 4/1 | 10500 | 4100 | 95-120 | 75 |

SMA ™ 3000 and SMA ™ EF40 are styrene-maleic anhydride polymers that can be hydrolyzed in water without a solvent while SMA ™ EF60, SMA ™ EF80, and SMA ™ 3840F are styrene-maleic anhydride polymers that are not hydrolysable in water without a solvent.

### Examples 1A-3B and Comparative Examples 1A-2B

Thermal stability tests were conducted with the aqueous dispersions of polymer modified black pigments of Examples 1-3 shown in Table 1 above, comprising the combination product of Black Pearls® 700 carbon black (commercially available from Cabot Corporation) and a styrene-maleic anhydride polymer (SMA™ 3840F for Example 1, SMA™ EF80 for Example 2, and SMA™ EF60 for Example 3) as well as for the aqueous dispersions of Comparative Examples 1 and 2, comprising the combination product of Black Pearls® 700 carbon black and SMA™ 3000 (for Comparative Example 1) and SMA™ EF40 (for Comparative Example 2). Two compositions were prepared for each example-A) 4% by weight pigment in water, and B) 4% by weight pigment in water with 10% by weight 1,2-hexandiol (1,2-HD). In addition, a third composition was prepared with the dispersion of Example 2-C) 4% by weight pigment in water with 10% by weight triethyleneglycol monobutyl ether (TEGMBE). Each composition was heated at 70° C., and the stability of the dispersions was monitored over several weeks at this temperature. Stable compositions are those in which <20% particle growth over the initial particle size is observed while unstable compositions are those in which a >20% increase in particle size is observed. Results are shown in Table 3 below.

TABLE 3

| Example # | Pigment | Polymer | Composition | Stability |
|---|---|---|---|---|
| 1A | BP700 | SMA ™ 3840F | A | Stable week 6 |
| 2A | BP700 | SMA ™ EF80 | A | Stable week 6 |
| 3A | BP700 | SMA ™ EF60 | A | Stable week 2* |
| Comp Ex 1A | BP700 | SMA ™ EF40 | A | Stable week 6 |
| Comp Ex 2A | BP700 | SMA ™ 3000 | A | Unstable week 6 |
| 1B | BP700 | SMA ™ 3840F | B | Stable week 6 |
| 2B | BP700 | SMA ™ EF80 | B | Stable week 6 |
| 3B | BP700 | SMA ™ EF60 | B | Stable week 2* |
| Comp Ex 1B | BP700 | SMA ™ EF40 | B | Unstable week 1 |
| Comp Ex 2B | BP700 | SMA ™ 3000 | B | Unstable week 1 |
| 2C | BP700 | SMA ™ EF80 | C | Stable week 6 |

*The thermal stability tests using these dispersions were monitored for 2 weeks only.

As the results in Table 3 show, the aqueous dispersions of Examples 1-3 were stable over 6 weeks at 70° C. in both formulations. In particular, the dispersion of Example 2 was stable for at least 6 weeks in multiple ink formulations. However, the dispersions of Comparative Example 1 was only stable in composition A and unstable in composition B, while the dispersion of Comparative Example 2 was unstable in both compositions. This indicates that the dispersions of Examples 1-3 are more stable and could therefore be used in inkjet ink compositions since no particle growth over time was observed in solvent containing formulations.

### Examples 4A-5B and Comparative Examples 3A-3B

Thermal stability tests were conducted for the aqueous dispersions of polymer modified cyan pigments of Examples 4-5 shown in Table 1 above, comprising the combination product of Pigment Blue 15:4 (TRB-6, commercially available from Daicolor Pope Inc.) and a styrene-maleic anhydride polymer (SMA™ 3840F for Example 4 and SMA™ EF80 for Example 5), as well as for the aqueous dispersion of Comparative Example 3, comprising the combination product of Pigment Blue 15:4, (wet cake prepared using a conventional pigment preparation) and SMA™ 3000. Two compositions were prepared for each example-A) 4% by weight pigment in water, and B) 4% by weight pigment in water with 10% by weight 1,2-hexandiol (1,2-HD). The thermal stability procedure described for Examples 1-3 and Comparative Examples 1 and 2 was used. Results are shown in Table 4 below.

TABLE 4

| Example # | Pigment | Polymer | Composition | Stability |
|---|---|---|---|---|
| 4A | PB15:4 | SMA ™ 3840F | A | Stable week 6 |
| 5A | PB15:4 | SMA ™ EF80 | A | Stable week 6 |
| Comp Ex 3A | PB15:4 | SMA ™ 3000 | A | Stable week 6 |
| 4B | PB15:4 | SMA ™ 3840F | B | Stable week 6 |
| 5B | PB15:4 | SMA ™ EF80 | B | Stable week 6 |
| Comp Ex 3B | PB15:4 | SMA ™ 3000 | B | Unstable week 0 |

As the results in Table 4 show, while the aqueous dispersions of Examples 4-5 and Comparative Example 3 were stable over 6 weeks at 70° C. in composition A, only those of Examples 4 and 5 were also stable in composition B, (containing an additional solvent.). The dispersion of Comparative Example 3 did not form a stable dispersion in composition B. This indicates that the aqueous dispersions of Examples 4 and 5 are more stable and could therefore be used in inkjet ink compositions since no particle growth over time was observed in a solvent containing formulation.

### Examples 6A-7A and Comparative Example 4A

Thermal stability tests were conducted for the aqueous dispersions of polymer modified magenta pigments of Examples 6-7 shown in Table 1 above, comprising the combination product of Pigment Red 122 (Sunfast Red 122 dry powder commercially available from Sun Chemical) and a styrene-maleic anhydride polymer (SMA™ 3840F for Example 6 and SMA™ EF80 for Example 7) as well as for the aqueous dispersion of Comparative Example 4, comprising the combination product of Pigment Red 122 (presscake commercially available from Sun Chemical) and SMA™ 3000. A 4% by weight pigment composition in water was prepared for each example. The thermal stability procedure described for Examples 1-3 and Comparative Examples 1 and 2 was used. Results are shown in Table 5 below.

TABLE 5

| Example # | Pigment | Polymer | Stability |
|---|---|---|---|
| 6A | PR122 | SMA ™ 3840F | Stable week 6 |
| 7A | PR122 | SMA ™ EF80 | Stable week 6 |
| Comp Ex 4A | PR122 | SMA ™ 3000 | Unstable week 4 |

As the results in Table 5 show, the aqueous dispersions of Examples 6 and 7 were stable at 4% by weight pigment over 6 weeks at 70° C. while the aqueous dispersion of Comparative Example 4 was not. This indicates that the aqueous dispersions of Examples 6 and 7 are more stable and could therefore be used in inkjet ink compositions since no particle growth over time was observed.

### Examples 8A-9A

Thermal stability tests were conducted for the aqueous dispersions of polymer modified yellow pigments of Examples 8-9 shown in Table 1 above, comprising the combination product of a yellow pigment (Pigment Yellow 155 for Example 8 and Pigment Yellow 180 for Example 9, both commercially available from Clariant) and a styrene-maleic anhydride polymer (SMA™ EF80). A 4% by weight pigment composition in water was prepared for each example. The thermal stability procedure described for Examples 1-3 and Comparative Examples 1 and 2 was used. Results are shown in Table 6 below.

TABLE 6

| Example # | Pigment | Polymer | Stability |
|---|---|---|---|
| 8A | PY155 | SMA ™ EF80 | Stable week 2 |
| 9A | PY180 | SMA ™ EF80 | Stable week 2 |

As the results in Table 6 show, the aqueous dispersions of Examples 8 and 9 were stable at 4% by weight pigment over 2 weeks at 70° C., which indicates that these aqueous dispersions could therefore be used in inkjet ink compositions since no particle growth over time was observed.

### Examples 10-18 and Comparative Examples 5-8

Examples 10-18 describe the preparation and print performance properties of inkjet ink compositions of the present invention while those of Comparative Examples 5-8 describe the preparation and print performance of comparative inkjet inks.

For each of these examples, images were printed using an Epson C88 printer on different papers selected from Hammermill Copy Plus (HCP), Xerox 4200 (X4200), Hewlett Packard Multicolorlok (HPM), and Hammermill Inkjet (HMIJ). Images were printed by loading the inkjet ink composition into an Epson compatible cartridge (available from Inkjet Warehouse, black cartridge part number E-0601-K, cyan cartridge part number E-0602-K) and printed with print settings “plain paper/best photo/ICM off”, and print performance properties were determined for the resulting printed images. The optical density (OD, or visual density) of a solid area fill at maximum print density was measured using ImageXpert™. Multiple measurements of OD were performed on a single print on each type of paper and averaged. Smear resistance was measured on high optical density stripes using a yellow Avery Fluorescent Hi-Lighter® Chisel Point #111646 and an orange ACCENT™ Highlighter Fluorescent Chisel Tip #25006. For each highlighter, two swipes were made on an unprinted section of paper, and then two swipes were made across three 2mm wide stripes printed 2 mm apart using the specified inkjet ink composition. The highlighter pen was cleaned between swipes on a piece of scrap paper. Smear resistance was visually evaluated to assess visible evidence of smearing from the printed stripe within the highlighter swipe: “poor”=noticeable smearing is observed, “good”=a slight amount of smearing is seen, and “excellent”=no smearing is found.

Inkjet ink compositions were prepared using the formulation shown in Table 7 below.

TABLE 7

| Ingredient | Amount |
|---|---|
| Glycerin | 10% |
| triethyleneglycol monobutyl ether | 5% |
| Surfynol 465 | 1% |
| Pigment | 4.5% |
| Water | 79.5% |

### Examples 10-13 and Comparative Examples 5-6

Inkjet ink composition of the present invention were prepared using the polymer modified black pigment dispersions of Examples 1-3, and comparative inkjet ink compositions were prepared using the dispersions of Comparative Examples 1-2. Optical density and smear resistance were measured as described above, and the results are shown in Table 8 below.

TABLE 8

| | Dispersion | Optical Density | | | | |
|---|---|---|---|---|---|---|
| Ex. # | Ex. # | HCP | X4200 | HPM | HMIJ | Smear |
| 10 | 1 | 1.31 | 1.34 | 1.45 | 1.32 | good/ |
| | | | | | | excellent |
| 11 | 2* | 1.19 | 1.30 | 1.44 | 1.22 | good |
| 12 | 3 | 1.14 | 1.19 | 1.42 | 1.16 | good |
| Comp Ex 5 | Comp Ex 1 | 1.14 | 1.19 | 1.33 | 1.13 | poor |
| Comp Ex 6 | Comp Ex 2 | 1.08 | 1.14 | 1.41 | 1.11 | poor |

*5% pigment and 79% water

The inkjet ink compositions of the present invention all printed well. As can be seen from the above print data, printed images on plain paper have OD equivalent to or higher than the comparative inkjet ink compositions. In addition, Examples 10-12 all showed improved smear resistance. Thus, inkjet ink compositions of the present invention have better overall print performance properties than the comparative inkjet ink compositions.

### Examples 13-14 and Comparative Example 7

Inkjet ink composition of the present invention were prepared using the polymer modified cyan pigment dispersions of Examples 4-5, and a comparative inkjet ink composition was prepared using the dispersion of Comparative Examples 3. Chroma and L* (lightness) were measured using a Hunter Color Meter, and the results are shown in Table 9 below.

TABLE 9

| Ex. # | Dispersion Ex. # | Paper | Chroma | L* | Chroma/L* |
|---|---|---|---|---|---|
| 13 | 4 | HCP | 47.62 | 45.80 | 1.04 |
| 14 | 5 | HCP | 46.67 | 45.10 | 1.03 |
| Comp Ex 7 | Comp Ex 3 | HCP | 45.00 | 46.82 | 0.96 |
| 13 | 4 | X4200 | 47.25 | 46.42 | 1.02 |
| 14 | 5 | X4200 | 46.75 | 46.28 | 1.01 |
| Comp Ex 7 | Comp Ex 3 | X4200 | 45.69 | 46.84 | 0.98 |
| 13 | 4 | HMIJ | 49.17 | 47.45 | 1.04 |
| 14 | 5 | HMIJ | 48.72 | 46.65 | 1.04 |
| Comp Ex 7 | Comp Ex 3 | HMIJ | 46.00 | 48.64 | 0.95 |

As can be seen from the above print data, the inkjet ink compositions of the present invention produce printed images on plain paper having improved color properties than those from the comparative inkjet ink compositions. In addition, improved optical density was also observed. Furthermore, when printed on Epson premium glossy photopaper, the inkjet ink compositions of the present invention produced images having good gloss, fast dry time ( <5 seconds), excellent waterfastness, and excellent wet and dry smear performance after only 2 minutes dry time (no smear observed). Thus, inkjet ink compositions of the present invention have better overall print performance properties than the comparative inkjet ink compositions.

### Examples 15-16 and Comparative Example 8

Inkjet ink composition of the present invention were prepared using the polymer modified magenta pigment dispersions of Examples 6-7, and a comparative inkjet ink composition was prepared using the dispersion of Comparative Examples 4. The inkjet ink compositions of the present invention showed excellent printability resulting in images having excellent print quality. For example, images printed on Epson premium glossy photopaper showed good gloss, fast dry time (<5 seconds), excellent waterfastness, good wet and dry smear performance after 2 minutes dry time, and excellent wet and dry smear after only 30 minutes dry time (no smear observed). It would be expected that the comparative inkjet ink composition would not show this level of print performance. Thus, inkjet ink compositions of the present invention have better overall print performance properties than the comparative inkjet ink compositions.

### Examples 17-18

Inkjet ink compositions of the present invention were prepared using the polymer modified yellow pigment dispersions of Examples 6-7. These inkjet ink compositions showed excellent printability resulting in images having excellent print quality. For example, images printed on Epson premium glossy photopaper showed good gloss, fast dry time (<5 seconds), excellent waterfastness, good wet and dry smear performance after 2 minutes dry time, and excellent wet and dry smear after only 30 minutes dry time (no smear observed).

The foregoing description of preferred embodiments of the present invention has been presented for the purposes of illustration and description. It is not intended to be exhaustive or to limit the invention to the precise form disclosed. Modifications and variations are possible in light of the above teachings, or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. An inkjet ink composition comprising a) a liquid vehicle; and b) at least one polymer modified pigment comprising the combination product of a pigment, a styrene-maleic anhydride polymer, and a base.

2. The inkjet ink composition of claim 1, wherein the styrene-maleic anhydride polymer is a styrene-maleic anhydride copolymer, a styrene-maleic anhydride-maleic acid ester polymer, or a styrene-maleic anhydride-maleic acid amide polymer.

3. The inkjet ink composition of claim 1, wherein the styrene-maleic anhydride polymer has an acid number of less than about 190.

4. The inkjet ink composition of claim 1, wherein the styrene-maleic anhydride polymer has an acid number of less than about 180.

5. The inkjet ink composition of claim 1, wherein the styrene-maleic anhydride polymer has an acid number of less than about 175.

6. The inkjet ink composition of claim 1, wherein the styrene-maleic anhydride polymer has a mole ratio of styrene to maleic anhydride of greater than or equal to about 5/1.

7. The inkjet ink composition of claim 8, wherein the mole ratio of styrene to maleic anhydride is greater than or equal to about 7/1.

8. The inkjet ink composition of claim 1, wherein the styrene-maleic anhydride polymer is a styrene-maleic anhydride-maleic acid ester polymer having a mole ratio of styrene to maleic anhydride and maleic acid ester of greater than or equal to about 4/1.

9. The inkjet ink composition of claim 1, wherein the styrene-maleic anhydride polymer is a styrene-maleic anhydride-maleic acid amide polymer having a mole ratio of styrene to maleic anhydride and maleic acid amide of greater than or equal to about 4/1.

10. The inkjet ink composition of claim 2, wherein the maleic acid ester comprises a C1-C20 alkyl, aralkyl, or aryl ester group.

11. The inkjet ink composition of claim 2, wherein the maleic acid ester comprises a C6-C18 alkyl, aralkyl, or aryl ester group.

12. The inkjet ink composition of claim 2, wherein the maleic acid amide comprises a C1-C20 alkyl, aralkyl, or aryl amide group.

13. The inkjet ink composition of claim 2, wherein the maleic acid amide comprises a C6-C18 alkyl, aralkyl, or aryl amide group.

14. The inkjet ink composition of claim 1, wherein the base is an hydroxide reagent.

15. The inkjet ink composition of claim 14, wherein the hydroxide reagent is sodium hydroxide, potassium hydroxide, lithium hydroxide, ammonium hydroxide, tetraalkyl ammonium hydroxide, or mixtures thereof.

16. The inkjet ink composition of claim 1, wherein the vehicle is an aqueous vehicle.

17. The inkjet ink composition of claim 1, wherein the pigment is an organic colored pigment comprising a blue pigment, a black pigment, a brown pigment, a cyan pigment, a green pigment, a white pigment, a violet pigment, a magenta pigment, a red pigment, a yellow pigment, an orange pigment, or mixtures thereof.

18. The inkjet ink composition of claim 1, wherein the pigment is carbon black.

19. The inkjet ink composition of claim 1, wherein the combination product comprises the pigment and a styrene-maleic acid polymer or a salt thereof.

20. The inkjet ink composition of claim 19, wherein the styrene-maleic acid polymer is a styrene-maleic acid copolymer, a styrene-maleic anhydride-maleic acid polymer, a styrene-maleic acid-maleic acid ester polymer, a styrene-maleic anhydride-maleic acid-maleic acid ester polymer, a styrene-maleic acid-maleic acid amide polymer, a styrene-maleic anhydride-maleic acid-maleic acid amide polymer, or a salt thereof.

21. An inkjet ink composition comprising a) a liquid vehicle, and b) at least one polymer modified pigment comprising a pigment and a styrene-maleic acid polymer or a salt thereof.

22. An inkjet ink composition comprising a) a liquid vehicle, and b) at least one polymer modified pigment comprising the combination product of a pigment, an alternating copolymer comprising at least one segment having the formula:
—[HB-A]ₓ-
wherein HB is a hydrophobic block, A is a polymerized monomer unit comprising at least one anhydride group, carboxylic ester group, carboxylic amide group, or mixtures thereof, and x is 5 to 50, and a base.

23. The inkjet ink composition of claim 22, wherein x is 7 to 30.

24. The inkjet ink composition of claim 22, wherein x is 10 to 25.

25. The ink jet ink composition of claim 22, wherein A is a polymerized maleic anhydride unit.

26. The inkjet ink composition of claim 22, wherein A is an ester derivative of a polymerized maleic anhydride unit.

27. The inkjet ink composition of claim 26, wherein the ester derivative comprises a C1-C20 alkyl, aralkyl, or aryl ester group.

28. The inkjet ink composition of claim 26, wherein the ester derivative comprises a C6-C18 alky, aralkyl, or aryl ester group.

29. The inkjet ink composition of claim 22, wherein A is an amide derivative of a polymerized maleic anhydride unit.

30. The inkjet ink composition of claim 29, wherein the amide derivative comprises a C1-C20 alkyl, aralkyl, or aryl amide group.

31. The inkjet ink composition of claim 29, wherein the amide derivative comprises a C6-C18 alky, aralkyl, or aryl amide group.

32. The inkjet ink composition of claim 22, wherein the alternating copolymer has an acid number of less than about 190.

33. The inkjet ink composition of claim 22, wherein the alternating copolymer has an acid number of less than about 180.

34. The inkjet ink composition of claim 22, wherein the alternating copolymer has an acid number of less than about 175.

35. The inkjet ink composition of claim 22, wherein HB is a hydrophobic block comprising polymerized styrene units.

36. The inkjet ink composition of claim 22, wherein HB is a polymerized styrene block.

37. The inkjet ink composition of claim 36, wherein the polymerized styrene block comprises greater than 3 polymerized styrene units.

38. The inkjet ink composition of claim 37, wherein the polymerized styrene block comprises greater than 6 polymerized styrene units.

39. The inkjet ink composition of claim 37, wherein the polymerized styrene block comprises greater than 8 polymerized styrene units.

40. The inkjet ink composition of claim 22, wherein the alternating copolymer is a styrene-maleic anhydride polymer.

41. The inkjet ink composition of claim 40, wherein the styrene-maleic anhydride polymer is a styrene-maleic anhydride copolymer, a styrene-maleic anhydride-maleic acid ester polymer, or a styrene-maleic anhydride-maleic acid amide polymer.

42. The inkjet ink composition of claim 22, wherein the base is an hydroxide reagent.

43. The inkjet ink composition of claim 42, wherein the hydroxide reagent is sodium hydroxide, potassium hydroxide, lithium hydroxide, ammonium hydroxide, tetraalkyl ammonium hydroxide, or mixtures thereof.

44. The inkjet ink composition of claim 22, wherein the vehicle is an aqueous vehicle.

45. The inkjet ink composition of claim 22, wherein the pigment is an organic colored pigment comprising a blue pigment, a black pigment, a brown pigment, a cyan pigment, a green pigment, a white pigment, a violet pigment, a magenta pigment, a red pigment, a yellow pigment, an orange pigment, or mixtures thereof.

46. The inkjet ink composition of claim 22, wherein the pigment is carbon black.

47. The inkjet ink composition of claim 22, wherein the combination product comprises the pigment and an alternating copolymer comprising at least one segment having the formula:
—[HB-A′]ₓ-
wherein HB is a hydrophobic block, A′ is a polymerized monomer unit comprising at least one carboxylic acid group or salt thereof, and x is 5 to 50.

48. The inkjet ink composition of claim 47, wherein the alternating copolymer is a styrene maleic acid polymer.

49. The inkjet ink composition of claim 48, wherein the styrene-maleic acid polymer is a styrene-maleic acid copolymer, a styrene-maleic anhydride-maleic acid polymer, a styrene-maleic acid-maleic acid ester polymer, a styrene-maleic anhydride-maleic acid-maleic acid ester polymer, a styrene-maleic acid-maleic acid amide polymer, a styrene-maleic anhydride-maleic acid-maleic acid amide polymer, or a salt thereof.

50. An inkjet ink composition comprising a) a liquid vehicle, and b) at least one polymer modified pigment comprising a pigment and an alternating copolymer comprising at least one segment having the formula:
—[HB-A′]ₓ-
wherein HB is a hydrophobic block, A′ is a polymerized monomer unit comprising at least one carboxylic acid group or salt thereof, and x is 5 to 50.

51. A method of forming a polymer modified pigment comprising the steps of:
i) combining a pigment and a styrene-maleic anhydride polymer; and
ii) reacting at least a portion of the styrene-maleic anhydride polymer with a base to form the polymer modified pigment comprising the pigment and a styrene-maleic acid polymer or salt thereof.

52. A method of forming a polymer modified pigment comprising the steps of:
i) combining a pigment and an alternating copolymer comprising at least one segment having the formula:
—[HB-A]ₓ-
wherein HB is a hydrophobic block, A is a polymerized monomer unit comprising at least one anhydride group, carboxylic ester group, carboxylic amide group, or mixtures thereof, and x is 5 to 50; and
ii) reacting at least a portion of the alternating copolymer with a base to form the polymer modified pigment comprising the pigment and an alternating copolymer comprising at least one segment having the formula:
—[HB-A′]ₓ-
wherein HB is the hydrophobic block, A′ is a polymerized monomer unit comprising at least one carboxylic acid group or salt thereof, and x is 5 to 50.
